(19) United States
(12) Patent Application Publication
(10) Pub. No.: US 2015/0130319 A1
(43) Pub. Date: May 14, 2015

(54) ROTOR AND MAGNET THEREOF

(71) Applicant: BIGBEST SOLUTIONS, INC., Taichung City (TW)

(72) Inventors: Chao-Pi CHANG, Nantou County (TW); Jia-Yuan LIANG, Nantou City (TW)

(21) Appl. No.: 14/076,802

(22) Filed: Nov. 11, 2013

(51) Int. Cl. H02K 1/27

(52) U.S. Cl. CPC H02K 1/2726
USPC 310/156.43

(57) ABSTRACT

An annular magnet includes a hollow magnet body having an outer circumferential surface that defines a cylindrical shape and an inner circumferential surface that defines an inlet hole. The inlet hole is adapted for receiving a back iron and has a cross-section substantially shaped in an equiangular polygon. The magnet body further has a plurality of magnetic sectors that surround a central axis of the inlet hole where the magnetic sectors correspond respectively to the sides of the equiangular polygon. Each of the magnetic sectors has a magnetic polarity opposite to that of an adjacent one of the magnetic sectors.

### BACKGROUND OF THE INVENTION

1. Field of the Invention

The invention relates to a rotor having a magnet, more particularly to rotor and a magnet thereof having an inner polygonal structure.

2. Description of the Related Art

Referring to FIG. 1, a conventional rotor includes a tubular back iron 1 and a plurality of magnets 2 disposed on the back iron 1. The back iron 1 is formed with a plurality of slots 11 that are angularly spaced apart from each other and that respectively receive the magnets 2 therein. Due to the dimensional tolerances respectively for the back iron 1 and the magnets 2, a fitted embedment of the magnets 2 in the slots 11 cannot be ensured. Therefore, when a rotating shaft (not shown) is inserted through the tubular back iron 1 and the conventional rotor is driven to rotate, the magnets 2 are easily displaced relative to the slots 11, resulting in vibration, and in noise and possible off-axis rotation in case of high-speed rotation.

Referring to FIG. 2, another conventional rotor includes a back iron 1 and an annular magnet 2. The magnet 2 has a cylindrical outer surface and a cylindrical inner surface that has a circular cross-section and that defines a space for receiving the back iron 1. The magnet 2 further has a plurality of magnetic sections 21 surrounding a central axis thereof where each of the magnetic sections 21 has a magnetic polarity opposite to that of an adjacent one of the magnetic sections 21. Due to the structural shape of the magnet 2, square waves are generated during magnetization when the conventional rotor rotates, thereby reducing operation efficiency of a motor that incorporates the rotor.

### SUMMARY OF THE INVENTION

Therefore, the object of the present invention is to provide a rotor and a magnet for a rotor that can eliminate the aforesaid drawbacks of the prior art.

According to one aspect of the present invention, there is provided an annular magnet for a rotor, comprising a hollow magnet body.

The magnet body has an outer circumferential surface that defines a cylindrical shape and an inner circumferential surface that defines an inlet hole. The inlet hole is adapted for receiving a back iron, and has a cross-section substantially shaped in an equiangular polygon. The magnet body further has a plurality of magnetic sectors that surround a central axis of the inlet hole. The magnetic sectors correspond respectively to the sides of the equiangular polygon. Each of the magnetic sectors has a magnetic polarity opposite to that of an adjacent one of the magnetic sectors. A thickness of the magnet body at a junction between two adjacent ones of the magnetic sectors is smaller than a thickness of the magnet body at a center portion of each of the magnetic sectors.

According to another aspect of the present invention, there is provided a rotor comprising the above-described magnet and a back iron mounted fittingly in the inlet hole, and formed with a through hole that extends along the central axis of the inlet hole.

### BRIEF DESCRIPTION OF THE DRAWINGS

Other features and advantages of the present invention will become apparent in the following detailed description of the preferred embodiment with reference to the accompanying drawings, of which:

FIG. 1 is a front view of a conventional rotor;

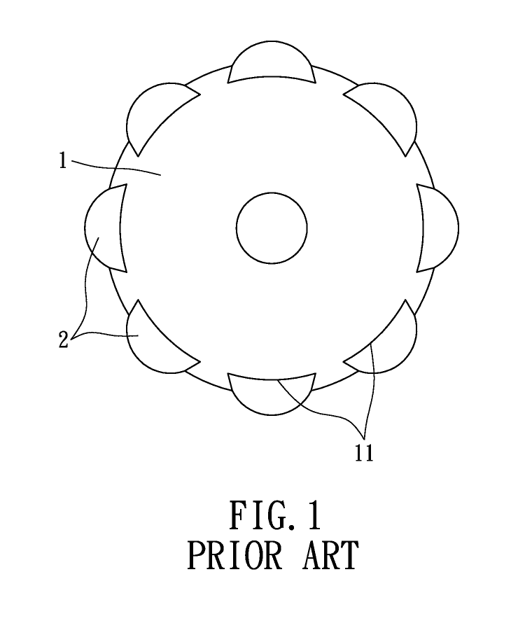

FIG. 2 is a front view of another conventional rotor;

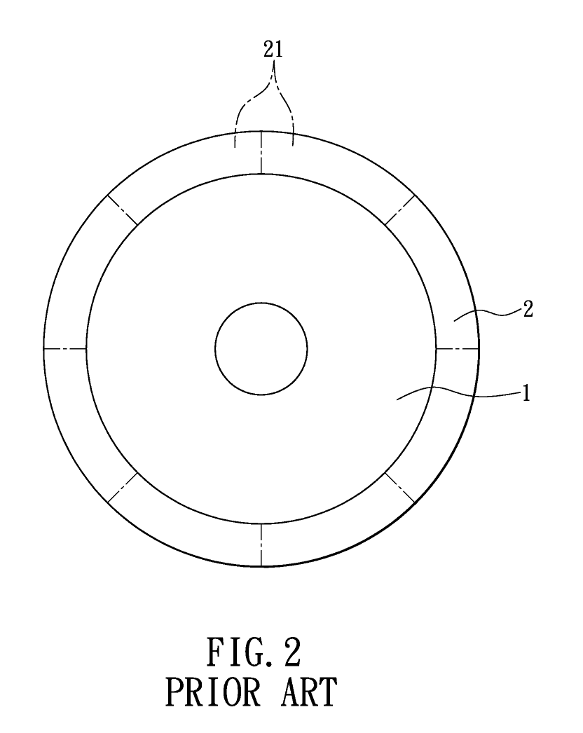

FIG. 3 is an exploded perspective view of a rotor according to the preferred embodiment of the present invention;

FIG. 4 is a perspective view of the preferred embodiment;

FIG. 5 is a front view of the preferred embodiment; and

FIG. 6 is a front view of a variation of the preferred embodiment.

### DETAILED DESCRIPTION OF THE PREFERRED EMBODIMENT

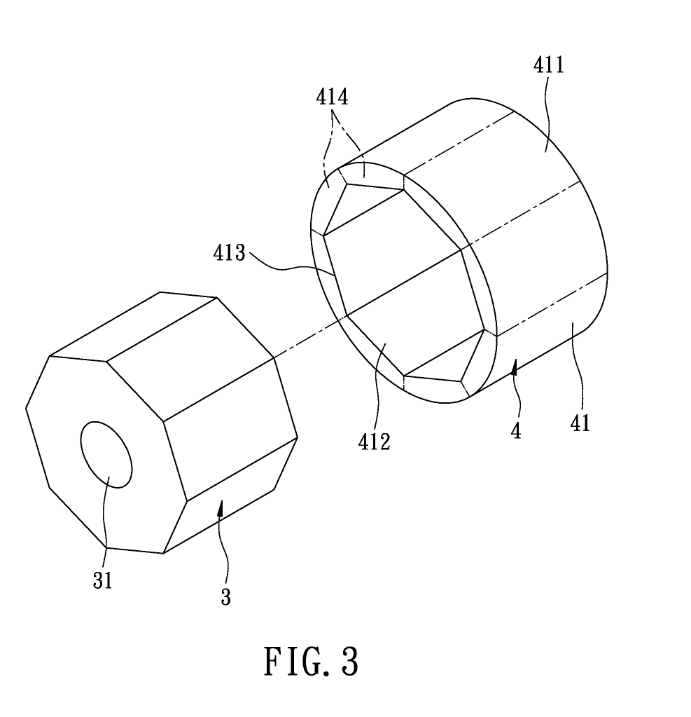

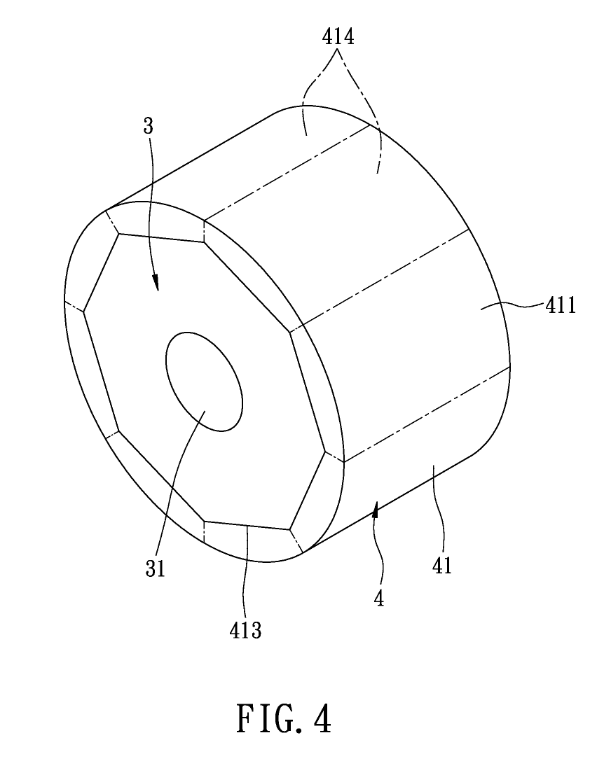

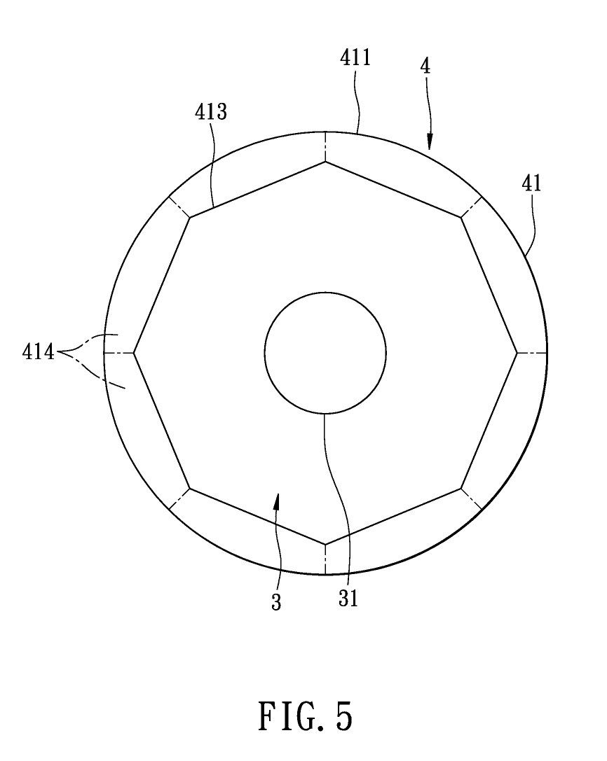

Referring to FIGS. 3, 4 and 5, the preferred embodiment of a rotor according to the present invention includes an annular magnet 4 and a back iron 3. The annular magnet 4 includes a hollow magnet body 41.

The magnet body 41 has an outer circumferential surface 411 and an inner circumferential surface 412. The outer circumferential surface 411 defines a cylindrical shape, whereas the inner circumferential surface 412 defines an inlet hole 413. The inlet hole 413 has a cross-section substantially shaped in an equiangular polygon that has an even number of sides not smaller than four.

The magnet body 41 further has a plurality of magnetic sectors 414 that surround a central axis of the inlet hole 413.

The magnetic sectors 414 correspond respectively to the sides of the equiangular polygon. Each of the magnetic sectors 414 has a magnetic polarity opposite to that of an adjacent one of the magnetic sectors 414. A thickness of the magnet body 41 at a junction between two adjacent magnetic sectors 414 is smaller than a thickness of the magnet body 41 at a center portion of each of the magnetic sectors 414.

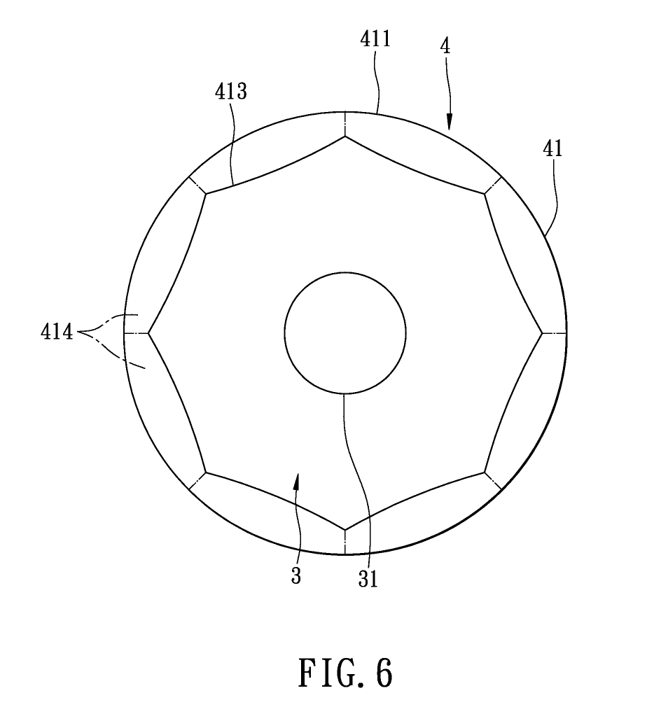

In this embodiment, the equiangular polygon is a regular octagon, and each of the sides of the equiangular polygon is straight. Preferably, referring to FIG. 6, each side of the equiangular polygon is curved towards the central axis of the inlet hole 413.

The back iron 3 is shaped to correspond to the inlet hole 413, i.e., also having a cross section that is substantially equiangular polygonal, is mounted fittingly in the inlet hole 413, and is formed with a through hole 31 that extends along the central axis of the inlet hole 413. In summary, due to the inner polygonal structure of the magnet 4, the back iron 3 can be easily fitted therein. Since both the inner structure of the magnet 4 and the back iron 3 have axially symmetric shapes, the rotor is allowed to maintain rotational precision and stability when driven to rotate by a rotation shaft (not shown), and relatively smooth sine waves can be created during magnetization when the rotor rotates, resulting in enhancement of operation efficiency and reduction of both vibration and noise levels for a motor incorporating the rotor.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An annular magnet for a rotor, comprising:
a hollow magnet body having an outer circumferential surface that defines a cylindrical shape and an inner circumferential surface that defines an inlet hole, which is adapted for receiving a back iron, and which has a cross-section substantially shaped in an equiangular polygon, said magnet body further having a plurality of magnetic sectors that surround a central axis of said inlet hole;
wherein said magnetic sectors correspond respectively to the sides of the equiangular polygon, each of said magnetic sectors having a magnetic polarity opposite to that of an adjacent one of said magnetic sectors, a thickness of said magnet body at a junction between two adjacent ones of said magnetic sectors being smaller than a thickness of said magnet body at a center portion of each of said magnetic sectors.

2. The magnet as claimed in claim 1, wherein the equiangular polygon has an even number of sides that is not smaller than four.

3. The magnet as claimed in claim 1, wherein each of the sides of the equiangular polygon is straight.

4. The magnet as claimed in claim 1, wherein each of the sides of the equiangular polygon is curved towards the central axis of said inlet hole.

5. A rotor comprising:
an annular magnet including a hollow magnet body that has an outer circumferential surface and an inner circumferential surface, said outer circumferential surface defining a cylindrical shape, said inner circumferential surface defining an inlet hole that has a cross-section substantially shaped in an equiangular polygon, said magnet body further having a plurality of magnetic sectors that surround a central axis of said inlet hole, said magnetic sectors corresponding respectively to the sides of the equiangular polygon, each of said magnetic sectors having a magnetic polarity opposite to that of an adjacent one of said magnetic sectors, a thickness of said magnet body at a junction between two adjacent ones of said magnetic sectors being smaller than a thickness of said magnet body at a center portion of each of said magnetic sectors; and
a back iron mounted fittingly in said inlet hole, and formed with a through hole that extends along the central axis of said inlet hole.

6. The rotor as claimed in claim 5, wherein the equiangular polygon has an even number of sides that is not smaller than four.

7. The rotor as claimed in claim 5, wherein each of the sides of the equiangular polygon is straight.

8. The rotor as claimed in claim 5, wherein each of the sides of the equiangular polygon is curved towards the central axis of said inlet hole.
